(19) United States
(12) Patent Application Publication
(10) Pub. No.: US 2013/0196544 A1
(43) Pub. Date: Aug. 1, 2013

(54) ELECTRICAL CONNECTOR WITH MULTIPLE DETECT MECHANISM THEREOF

(71) Applicants: TERRANCE F. LITTLE, Fullerton, CA (US); STEPHEN SEDIO, Valley Center, CA (US); AN-JEN YANG, Irvine, CA (US)

(72) Inventors: TERRANCE F. LITTLE, Fullerton, CA (US); STEPHEN SEDIO, Valley Center, CA (US); AN-JEN YANG, Irvine, CA (US)

(21) Appl. No.: 13/753,546

(22) Filed: Jan. 30, 2013

Related U.S. Application Data
(60) Provisional application No. 61/593,826, filed on Feb. 1, 2012.

(51) Int. Cl. H01R 12/71

(52) U.S. Cl. CPC H01R 12/71
USPC 439/626

(57) ABSTRACT

An electrical connector, adapted for mounting to a mother board and mating with a plug, includes an insulative housing with a mating tongue forwardly extending therefrom, a plurality of contacts disposed in the housing with contacting sections exposed on the mating tongue and a metallic shell covering the housing. The metallic shell defines a mating cavity surrounding the mating tongue and has a plurality of spring tangs extending into the mating cavity. A detect member is assembled to a bottom of the electrical connector, and includes a printed circuit board with some dome switches under corresponding spring tang and some additional detection pins electrically connecting the dome switches. When the plug is inserted, the spring tangs will deflect downwardly and activate the dome switch.

### CROSS REFERENCE TO RELATED APPLICATIONS

This application claims the benefit of, and priority to, U.S. Provisional Patent Application No. 61/593,826, filed Feb. 1, 2012, the contents of which are incorporated entirely herein by reference.

### BACKGROUND OF THE INVENTION

1. Field of the Invention

The present invention relates to an electrical connector, and more particular to the USB (Universal Serial Bus) connector equipped with detection pins associated with an activation device thereof.

2. Description of the Related Art

The USB connector as an interface, is popularly used in the industry. Even of the USB connector carries power constantly, in some situation a relatively large power is required. Therefore, it is expected to have the receptacle connector, which is mounted upon the mother board, equipped with detection pins to identify whether the mated plug requires the relatively high power. On the other hand, the additional detection pins used in the conventional USB receptacle connector essentially extend into the mating cavity for activation by the inserted plug, and in some case the corresponding metallic shell, which confines/surround the mating cavity, may be required to be modified for corresponding to such additional detection pins. Such modification may potentially jeopardize the electrical and mechanical performance of the metallic shell and induce improper shoring.

However, a USB connector quipped with the detect pin optionally without scarification the original mechanism and electrical performance is desired.

### SUMMARY OF THE INVENTION

Accordingly, an object of the present invention is to provide an electrical connector having a detect mechanism.

In order to achieve the object set forth, an electrical connector for use with a plug comprises an insulative housing defining a mating tongue; a metallic shell assembled to the housing, a plurality of contacts disposed in the insulative housing with contacting sections exposed upon the mating tongue; and a printed circuit board. The insulative housing defines a mating cavity into which the mating tongue extends. Said shell has a plurality of spring tangs extending into the mating cavity. The printed circuit board located under the shell and equipped with thereon at least one dome switch vertically aligned with the corresponding spring tang. Upon insertion of the plug, the spring tang is outwardly deflected to activate the at least one dome switch, respectively.

Other objects, advantages and novel features of the invention will become more apparent from the following detailed description of the present embodiment when taken in conjunction with the accompanying drawings.

### BRIEF DESCRIPTION OF THE DRAWINGS

FIG. 1 is an assembled, perspective view showing an electrical connector in a first embodiment in accordance with the present invention;

FIG. 2 is an upside-down perspective view showing the electrical connector in FIG. 1 without a print circuit board and an associated flexible member;

FIG. 3 is an upside-down perspective view showing the connector in FIG. 1;

FIG. 4 is an enlarged perspective view to show the printed circuit board with dome switches thereon;

FIG. 5 is an enlarged perspective view to show the printed circuit board is associated with the flexible member;

FIG. 6 is an enlarged perspective view to show the flexible member;

FIG. 7 is an assembled, perspective view showing another electrical USB connector in a second embodiment in accordance with of the present invention;

FIG. 8 is an assembled, perspective view showing the electrical USB connector in FIG. 7 from a bottom side;

FIG. 9 is a perspective view showing the electrical connector in FIG. 7, wherein a print circuit board and an associated flexible member are detached from the electrical connector;

FIG. 10 is a similar with FIG. 9, taken from another side; and

FIG. 11 is an exploded, perspective view showing the electrical USB connector in FIG. 7, without the print circuit board and the flexible member.

### DETAILED DESCRIPTION OF THE INVENTION

Reference will be made to the drawing figures to describe the present invention in detail, wherein depicted elements are not necessarily shown to scale and wherein like or similar elements are designated by same or similar reference numeral through the several views and same or similar terminology.

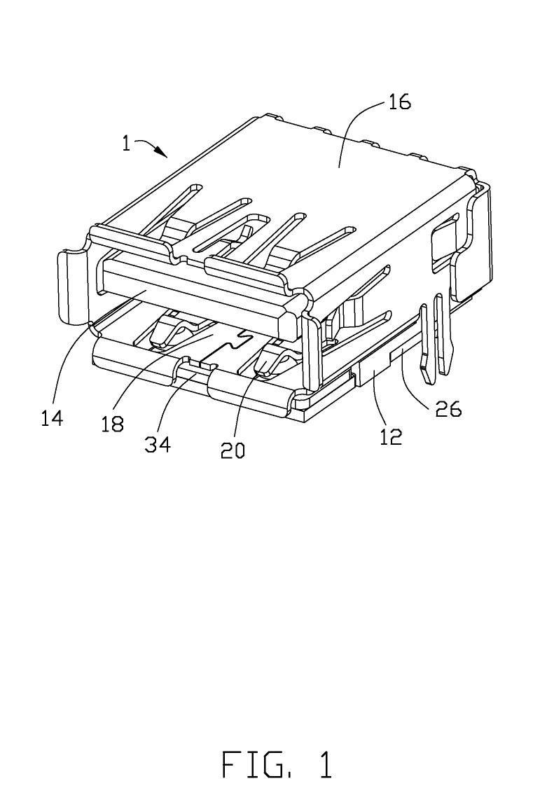

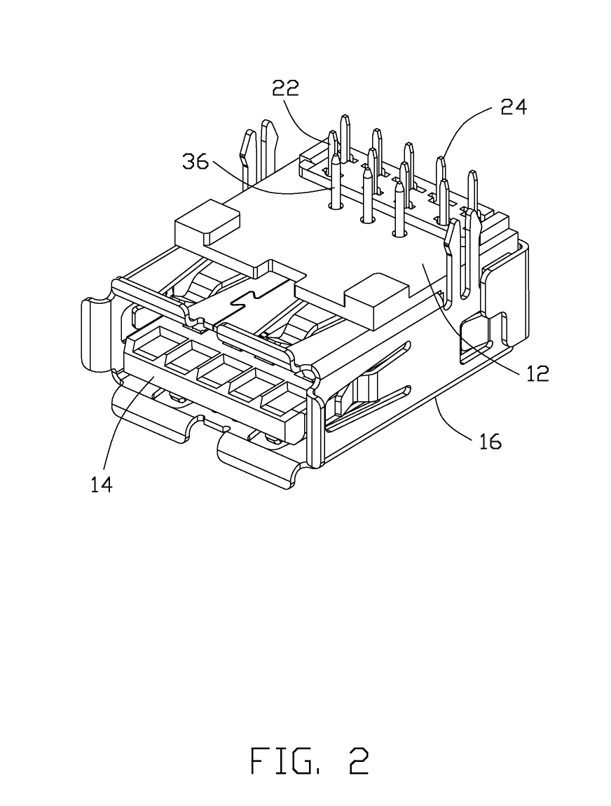

Referring to FIG. 1 to FIG. 2, an electrical connector 1 in accordance with an embodiment of the present invention is provided and configured as a USB 3.0 receptacle for being mounted on a mother board, it should be pointed out that the other similar electrical connectors, such as USB 2.0 connector, eSATA connector, DisplayPort connector and et al, are also suitable for incorporation of the present invention. The electrical connector 1 has a substantial same configuration as that of USB 3.0 receptacle. A conventional USB 3.0 receptacle are described in detail in many patents, such as U.S. Pat. No. 7,625,243, the disclosure of which are incorporated herein by reference to the extent not inconsistent herewith.

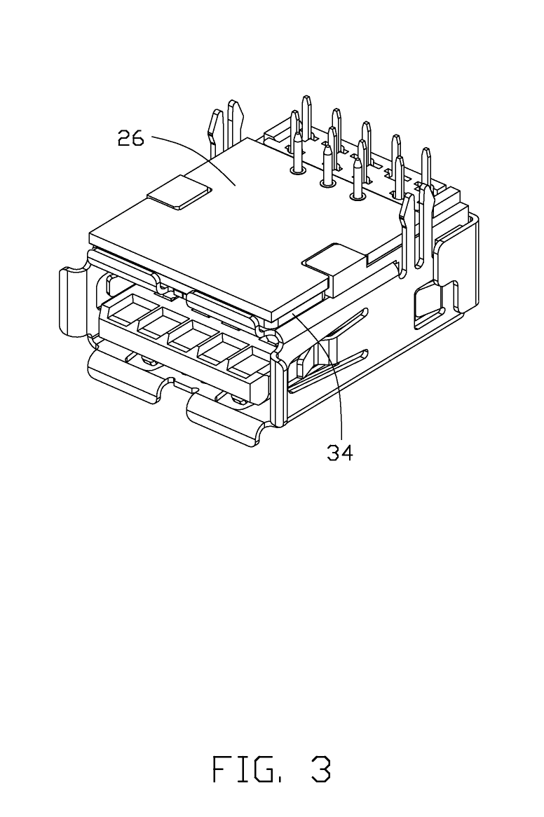

FIGS. 2-3 illustrate the electrical connector 1 in present embodiment, includes an insulative housing 12, a metallic shell 16 covering the insulative housing 12 and a plurality of conductive contacts retained in the insulative housing 12. The insulative housing 12 is formed with a mating tongue 14, the mating tongue 14 extends forwardly and is integrated with the insulative housing 12. The conductive contacts consist of nine pins, including four deflectable contacts 22 and five stationary contacts 24, each conductive contact has a contacting section. All of these contacting sections are exposed on a same surface of mating tongue 14 and jointly compliance to USB 3.0 standard, that is say the contacting sections of the stationary contacts 24 are arranged in a front row and the contacting sections of the four deflectable contacts 22 are arranged in a rear row behind the front row.

The metallic shell 16 is assembled to and covers the insulative housing 12 to define a mating cavity 18 into which the mating tongue 14 extends. The metallic shell 16 has a top wall, a bottom wall and two side walls connecting the top wall and the bottom wall. Each of the top wall and the bottom wall is unitarily formed with two spring tangs 20, which extending inwardly into the mating cavity 18. Two mounting legs (not labeled) extend from the side walls to be mounted on the mother board (not shown).

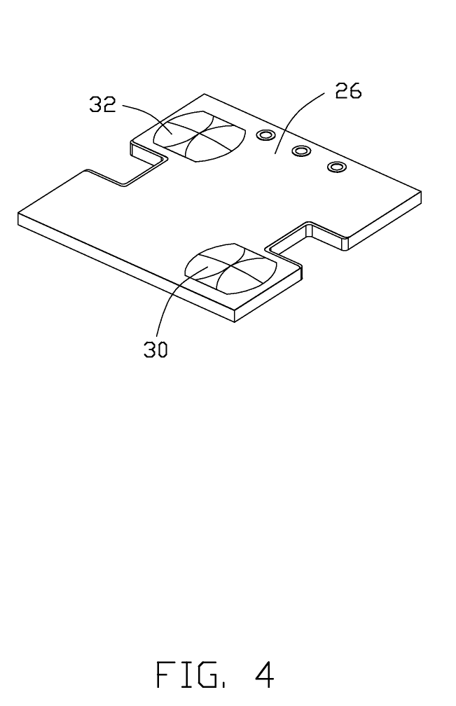

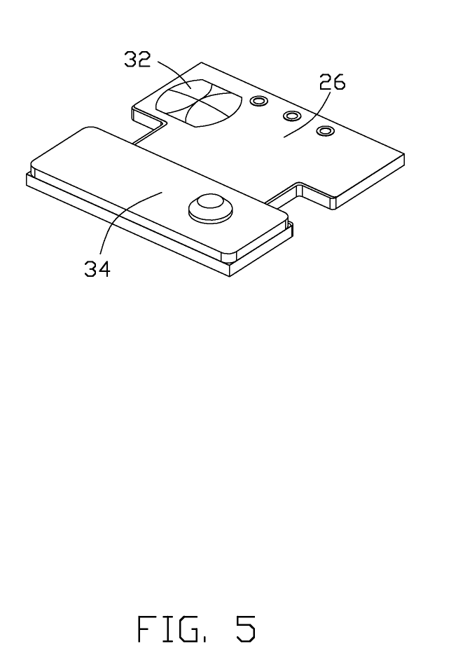

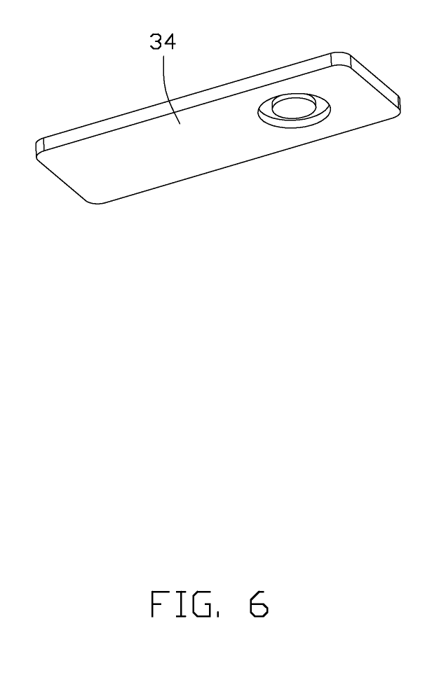

Referring to FIGS. 4-6, conjoined with FIG. 3, a detect member is provided on the electrical connector 1 for plug insertion detection, which is intimately located under the electrical connector. The detect member includes a printed circuit board 26 and a flexible member 34 covering the printed circuit board 26 to protect the printed circuit board 26. The printed circuit 26 is formed with an insertion detect dome switch 30 at a front right corner thereof, and a PD (power delivery) detect dome switch 32 at a rear left corner thereof for PD plug detection. The flexible member 34 is formed with a button upwardly protruding as observed from a top side but recessed upwardly as observed from a bottom side. The button is disposed above the insertion detect dome switch 30 so as to activate the insertion detect dome switch 30 when the button is pressed downwardly.

Three tubes not (labeled) are formed on a rear edge of the printed circuit board 26 and electrically connect with the dome switches 30, 32 by conductive traces within the printed circuit board. Three additional detection pins 36 are provided to electrically link the tubes and the dome switches 30, 32. In present embedment, the additional detection pin 36 are retained to the housing 12, and extend through the printed circuit board 26 to be mounted to the mother board (not shown), so as to electrically connect dome switches 30, 32 to the mother board (not shown) and transmit the detection signals. Alternatively, the additional detection pins 36 may directly retained to the printed circuit board 26.

Referring to FIG. 2, the insulative housing 12 has a supporting plate outside the bottom wall of the metallic shell 16, which is shorter than the bottom wall so a front part of the bottom wall of the metallic shell 16 is exposed downwardly. The printed circuit board 26 together with the flexible member 34 thereon is attached to the bottom of the insulative housing 12 and the metallic shell 16, the flexible member 34 is located under the exposed front part of the bottom wall, the printed circuit board 26 upwardly abuts the supporting plate. The printed circuit board 26 has two gaps on two lateral sides thereof, the supporting plate has corresponding protrusions to engage with the gaps to position the printed circuit board 26. Finally, the flexible member 34 is vertically located under the spring tangs 20, and the button is vertically aligned with a portion of the corresponding spring tang 20 around a front portion of the mating cavity 18. And the inserted dome switch 30 of the printed circuit board 26 is disposed under the button to be activated by the button.

When a regular plug or a PD plug or other mating plug is inserted into the mating cavity 18, the spring tang 20 is outwardly deflected by the inserted plug to activate, via the button of the flexible member 34, the insertion detect dome switch 30 and the corresponding detection pin or pins 36 for verifying insertion of the plug. When the inserted plug is a PD plug, which requires the high power and is configured with a longer dimension of a mating portion in a front-to-back direction than a regular one, the rear dome switch 32 will be activated to identify the inserted plug is a PD plug and can provide a high power delivery, while the regular plug can not activate the rear dome switch 32.

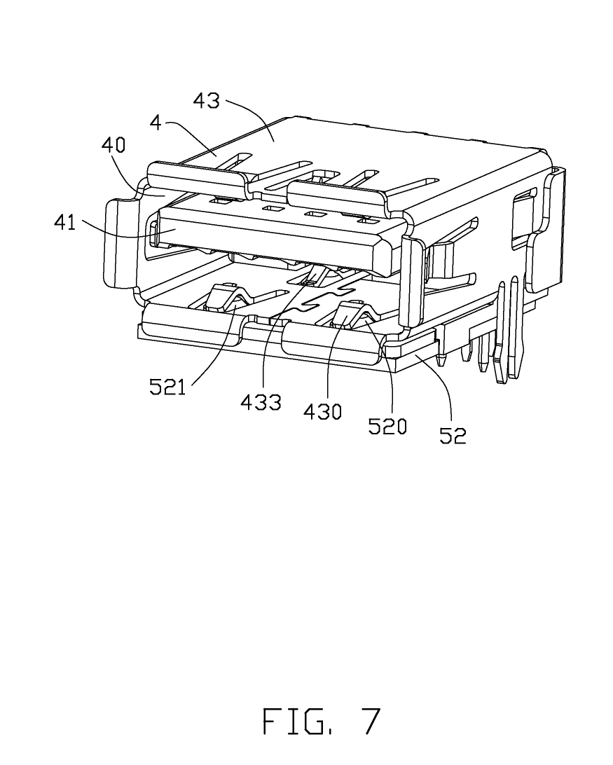

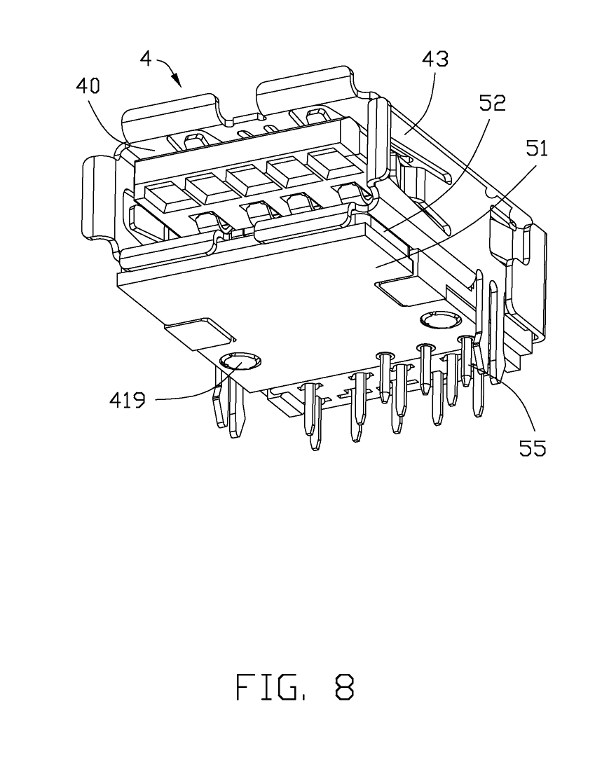

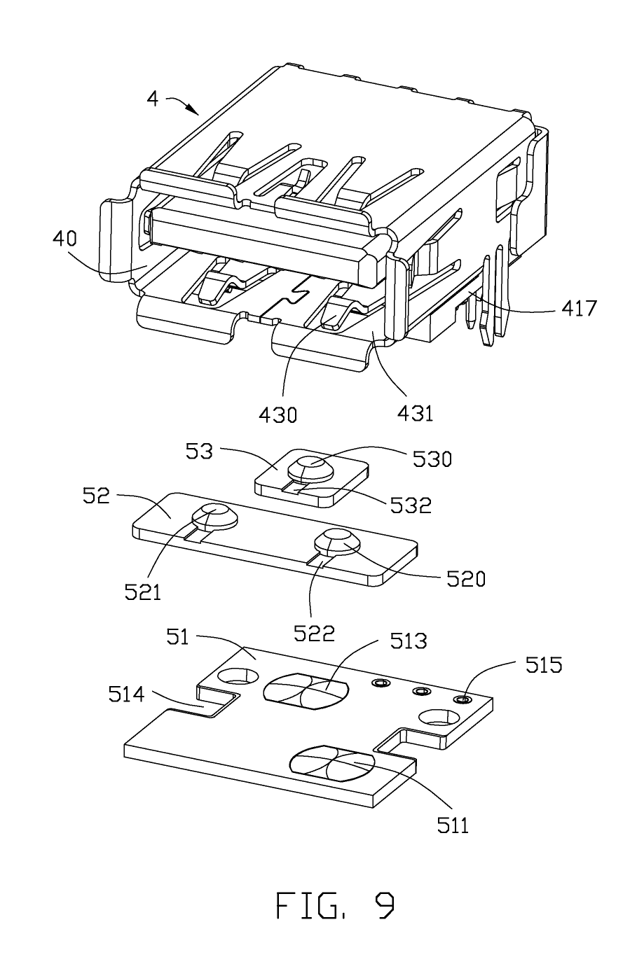

The electrical connector 1 in the first embodiment is a rough manner, it should be noted that in the current embodiment, the housing is presented in a rough manner. In fact, the rear portion of the housing should remove a portion for communicating the rear dome switch with the corresponding spring tang of the shell. FIGS. 7-11 illustrate another electrical connector 4 in a second embodiment in accordance with present invention. The another electrical connector 4 has a similar configure with the electrical connector 1 in the first embodiment and also be a USB 3.0 receptacle. The electrical connector 4 has an insulative housing 41, a plurality of conductive contacts 42 retained to the insulative housing 41, a shell 43 covering the insulative housing 41 and a detect member 50 disposed to the bottom of the electrical connector 4.

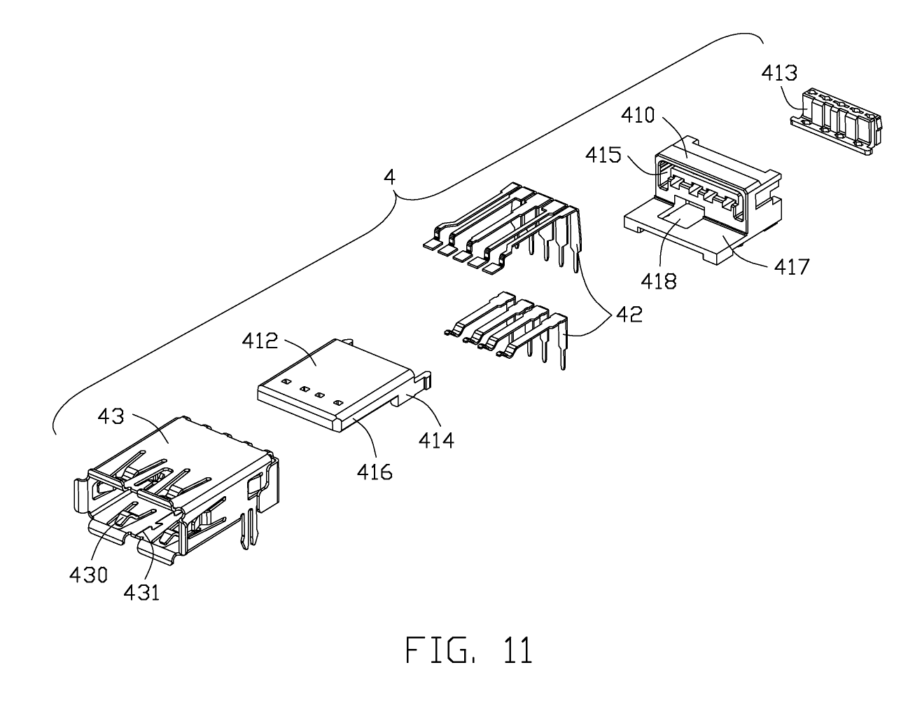

Conjoined with FIG. 11, the insulative housing 41 has a base 411, a tongue plate 412 retained to the base 410 and a spacer 413 attached to a rear end of the base 410 to position tails of the conductive contacts 42. The tongue plate 412 is formed with retention portions 414 received in a retaining slot 415 of the base 410 to retain tongue plate 412 to the base 410 and a mating tongue 416 extending forwardly from the retention portions 414. The base 410 further has a supporting plate 417 extending forwardly from a bottom of the base 410. The conductive contacts 42 consist of nine pins, four deflectable contacts and five stationary contacts, all of contacting sections of these contacts are exposed on a same surface of mating tongue 416, the type and arrangements of the conductive contacts 42 are same as the conductive contacts 22, 24 of the electrical connector 1 to compliance with USB 3.0 standard, here will not give unnecessary description.

Referring FIGS. 7-9, the shell 43 has a substantially same configuration as the shell 13 in the first embodiment and defines a mating cavity 40 into which the mating tongue 416 extends, the shell 43 has a plurality of spring tangs 430 extending into the mating cavity 40 from peripheral walls thereof. The shell 43 has a bottom wall 431 with the spring tangs 430, and the supporting plate 417 of the insulative housing 41 is located outside the shell 43 and faces the bottom wall 431 of the shell 43.

The detect member 50 includes a printed circuit board 51, a first flexible member 52 put on a front of the printed circuit board 51 and a second flexible member 53 put on a rear of the printed circuit board 51. The printed circuit board 51 has a substantially configuration as the printed circuit board 26 in the first embodiment, having a front dome switch 511, a rear dome switch 513, two notches 514 on two opposite sides for engaging with two clumps 418 on the supporting plate 417 and three tubes 515 on a rear edge thereof. The first flexible member 52 is similar with the flexible member 34 in the first embodiment, and has a same button 520 vertically aligned with the front dome switch 511. A plurality of additional detection pins 55 are also provided which are retained to the insulative housing 41 and extend through the tubes 515 of the printed circuit board 51 for electrically connecting the dome switches 511, 513 to the mother board.

Similar as the first embodiment, when the plug (shown) is inserted, the spring tang 430 on the bottom wall 431 outwardly deflects and forces the button 520 to activate the front dome switch 511, for an detection of the inserted plug. The first flexible member 52 is further formed with another button 521 beside the button 520, no dome switch is below the another button 521, but the another button 521 is pressed by another spring tang 430 of a bottom wall 431 of the shell 43 so as to balance the force when the plug is inserted.

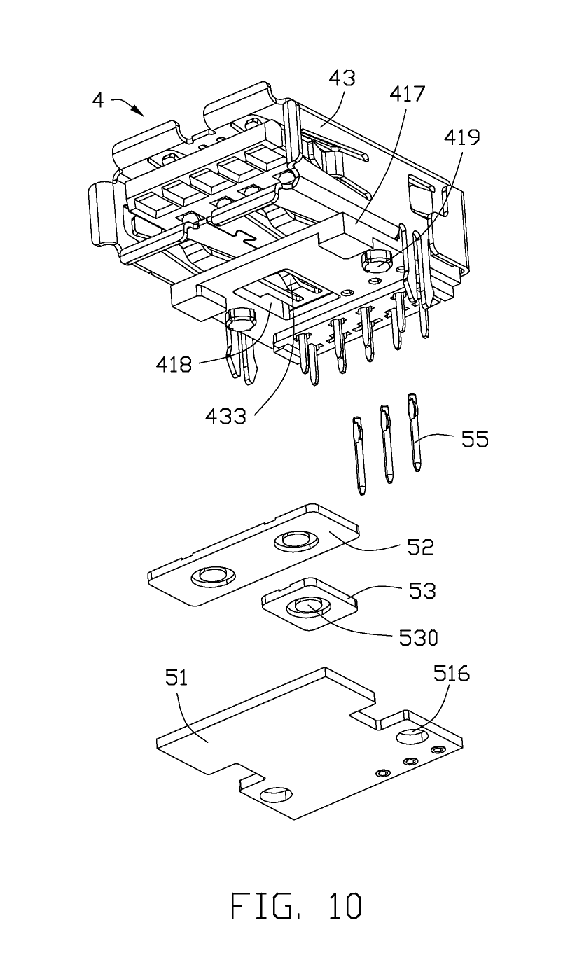

Conjoined with FIG. 10, the second flexible member 53 is added compared with the first embodiment, which has a button 530 thereon for activating the rear dome switch 513. The shell 43 further has a spring finger 433 extending into the mating cavity 40 from a rear of the bottom wall 431. The supporting plate 417 is added with an opening 418 corresponding to the spring finger 433, the button 530 of the second flexible member 53 protrudes into the mating cavity 40 via the opening 418 to be under the spring finger 433. When the inserted plug is PD plug with a longer dimension of the mating portion, the spring finger 433 is be depressed by the PD plug, and presses the button 530 to activate the rear dome switch 513 then the inserted PD plug is identified as a PD plug which can transmit a high power delivery, while the regular plug can not press the spring finger 433 and the rear dome switch 32 will not be activated.

The printed circuit board 51 further has a pair of mounting holes 516, and the supporting plate 417 of the insulative housing 41 is disposed with a pair of posts 419 to engage with the mounting holes 516. Another improvement is that the flexible members 52, 53 further have a plurality of slots 522, 532 in front of the buttons 520, 521, 530, when the regular plug/PD plug is inserted, front tips of the spring tang 530 and the spring finger 533 are pressed outwardly and slide forwardly in the slots 522, 532, and will deeply crash the flexible members 52, 53.

Alternatively in a simplified structure the dome switch with the associated flexible member may be directly activated by the inserted plug instead of through the spring tang. Furthermore, the flexible member 34/52/53 tightly attached upon the printed circuit board around the dome switch in a sealed manner may prevent contamination of the dome switch advantageously, the first and the second flexible members 52, 53 may be made in one piece, the additional detection pin 36/55 may retained on the printed circuit board 26/51. One feature of the invention is to provide a transition mechanism, i.e., the dome switch and the associated printed circuit board, between the detection pin and the inserted plug instead of direct confrontation between the inserted plug and the detection pin.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An electrical connector for use with a plug comprising:
an insulative housing defining a mating tongue;
a metallic shell assembled to the housing and defining a mating cavity into which the mating tongue extends, said shell having a plurality of spring tangs extending into the mating cavity;
a plurality of contacts disposed in the insulative housing with contacting sections exposed upon the mating tongue; and
a printed circuit board located under the shell and equipped with thereon at least one dome switch vertically aligned with the corresponding spring tang; wherein
upon insertion of the plug, the spring tang is outwardly deflected to activate the at least one dome switch.

2. The electrical connector as described in claim 1, wherein the at least one dome switch is covered by a flexible member for anti-contamination.

3. The electrical connector as described in claim 2, wherein the flexible member has a button aligned with the at least one dome switch along a top-to-bottom direction and protruding upwardly so that the outwardly deflected spring tang can depress the button, than the button activates the at least one dome switch below.

4. The electrical connector as described in claim 3, wherein the flexible member has a slot in front of the button to receive a corresponding front tip of the spring tang.

5. The electrical connector as described in claim 1, further comprising at least one additional detection pin and the contacts mechanically and electrically associated with the printed circuit board to electrically connecting with the at least one dome switch, both of the additional detection pin and the contacts extend downwardly for being mounted to a mother board.

6. The electrical connector as described in claim 5, wherein the printed circuit board has a tube through which the at least one additional detection pin pass to electrically connect with said at least one dome switch via the tube.

7. The electrical connector as described in claim 2, wherein the insulative housing has a supporting plate outside a bottom wall of the shell, and the bottom wall has an exposed front part without overlapping with the supporting plate, the printed circuit board attached with the flexible member is assembled to the bottom of the shell and the insulative housing, the flexible member upwardly abuts the exposed front part of the shell, the printed circuit upwardly abut the supporting plate.

8. The electrical connector as described in claim 7, wherein the supporting plate has protrusions and the printed circuit board has gaps engaging with protrusion to position the printed circuit board.

9. The electrical connector as described in claim 1, wherein the printed circuit board has two said dome switches, including a front dome switch at the front of the printed circuit board for plug insertion detection, and a rear dome switch at the rear for a power delivery plug insertion detection which is configured with a longer dimension of a mating portion in a front-to-back direction than a regular one.

10. The electrical connector as described in claim 9, wherein the flexible member includes a first flexible member covering the front dome switch, and a second flexible member covering the rear dome switch, the first flexible member has two buttons, only one has the front dome switch below, but both buttons are pressed by the spring tangs when the plug is inserted to balance the force.

11. The electrical connector as described in claim 9, wherein the shell is formed with a spring finger at a rear of the mating cavity, the supporting plate defines a through opening corresponding to the spring finger, and the spring finger activates the rear dome switch via the opening.

12. An electrical connector for use with a plug comprising:
an insulative housing enclosed in a metallic shell to commonly define a mating port;
a plurality of contacts disposed in the housing with contacting sections exposed in the mating port;
at least one dome switch moveable in a direction perpendicular to a front-to-back direction and adapted to be activated by the plug received in the mating port; and
at least one detection pin electrically connected to the dome switch; wherein
tails of the said contact and that of the detection pin are both arranged in a rear side of the housing.

13. The electrical connector as described in claim 12, wherein the dome switch is formed on a printed circuit board to which the detection pin is mechanically and electrically connected.

14. The electrical connector as described in claim 5, wherein the shell has a spring tang extending into the mating port and adapted to be outwardly deflected by the inserted plug to activate the dome switch.

15. The electrical connector as described in claim 4, further comprising a flexible member covering the printed circuit board, the flexible member has two buttons, only one has the at least one dome switch dome below, the shell has a plurality of said spring tang, both buttons are pressed by the spring tangs when the plug is inserted to balance the force.

16. An electrical connector for use with two different plugs having a same contact arrangement while having different shell lengths with different power supplying, comprising:
an insulative housing cooperating with a metallic shell to commonly define a mating port;
a plurality of contacts disposed in the housing with tail sections exposed upon a rear side of the housing for mounting to a mother board; and
a printed circuit board associated with at least one of said housing and said shell and defining thereof a dome switch and at least a detect pin electrically connected to said dome switch for mounting to the mother board; wherein
said dome switch is located at a position around a rear side of the housing so as to be adapted to be activated by the plug having a longer shell than the other of said two different plugs.

17. The electrical connector as claimed in claim 16, wherein the printed circuit board is located below the metallic shell for confronting the mother board.

18. The electrical connector as claimed in claim 16, further including a flexible member covering the dome switch and located between the printed circuit board and the metallic shell.

19. The electrical connector as claimed in claim 16, wherein said housing includes a supporting plate located under the metallic shell, and said supporting plate defines a through opening to receive said flexible member.

20. The electrical connector as claimed in claim 16, wherein said dome switch is aligned with and adapted to be actuated by a spring tang of said metallic shell which extends into the mating port for retaining the plug during mating.
